(19) United States
(12) Patent Application Publication
(10) Pub. No.: US 2024/0185628 A1
(43) Pub. Date: Jun. 6, 2024

(54) CLIENT TERMINAL, CONTROL METHOD FOR CLIENT TERMINAL, AND STORAGE MEDIUM

(71) Applicant: CANON KABUSHIKI KAISHA, Tokyo (JP)

(72) Inventor: KOTARO MATSUDA, Kanagawa (JP)

(21) Appl. No.: 18/525,581

(22) Filed: Nov. 30, 2023

(30) Foreign Application Priority Data
Dec. 1, 2022 (JP) 2022-192636

(51) Int. Cl. G06V 30/14; G06F 3/0482; G06F 3/0485; G06V 30/146

(52) U.S. Cl. CPC G06V 30/1456; G06F 3/0482; G06F 3/0485; G06V 30/147

(57) ABSTRACT

A client terminal configured to acquire image data acquired from a document, perform character recognition processing on the image data, and control display of at least a partial area of the image data specified based on an instruction issued by a user and display of a list of character strings acquired by the character recognition processing. As at least the partial area to be displayed is changed, the list of character strings is changed so that character strings recognized in at least the partial area are displayed.

### BACKGROUND OF THE DISCLOSURE

### Field of the Disclosure

The present disclosure relates to a user interface which displays a list of character strings included in image data.

### Description of the Related Art

There has been an increased demand for improving the operational efficiency of document processing work on digitized paper documents with an information technology (IT) system as part of the shift toward digital transformation in recent years. First, a paper document is scanned or image-captured, and the image of the paper is filed electronically. Examples of paper documents include various types of documents, such as purchase orders, billing statements, and application forms. Extraction and use of character strings described on documents from image files through optical character recognition (OCR) processing can improve the operational efficiency of document processing work on these various types of documents.

Japanese Patent Application Laid-Open No. 2020-086717 discusses a technique of displaying a list of character strings acquired through character recognition processing on image data, and using a character string selected from the list in a folder name as a transmission destination of a file where the image data is included. The list is displayed for each page together with corresponding image data.

However, Japanese Patent Application Laid-Open No. 2020-086717 does not discuss a case where a display area is changed within image data corresponding to one page. For example, it is conceivable that a user changes a display area by enlarging or reducing image data and/or by moving a display area to another area within the image data. According to the technique discussed in Japanese Patent Application Laid-Open No. 2020-086717, a list of character strings cannot be displayed appropriately depending on a change of a display area.

### SUMMARY OF THE DISCLOSURE

The present disclosure is directed to a technique for appropriately displaying a list of character strings acquired through character recognition processing on image data according to a change of a display area in the image data.

According to an aspect of the present disclosure, a client terminal configured to acquire image data acquired from a document, perform character recognition processing on the image data, and control display of at least a partial area of the image data specified based on an instruction issued by a user and display of a list of character strings acquired by the character recognition processing. As at least the partial area to be displayed is changed, the list of character strings is changed so that character strings recognized in at least the partial area are displayed.

Further features of the present disclosure will become apparent from the following description of exemplary embodiments with reference to the attached drawings.

### BRIEF DESCRIPTION OF THE DRAWINGS

FIG. 1 is a diagram illustrating a system configuration and a network configuration according to a first exemplary embodiment for implementing the present disclosure.

FIG. 2 is a diagram illustrating a configuration of hardware relating to information processing functions of an information processing apparatus according to the present exemplary embodiment of the present disclosure.

FIG. 3 is a block diagram illustrating a software configuration and a hardware configuration of a system according to the present exemplary embodiment of the present disclosure.

FIG. 4 is a flowchart illustrating processing according to the present exemplary embodiment of the present disclosure.

FIG. 5 is a diagram illustrating a document image according to the present exemplary embodiment of the present disclosure.

FIGS. 6A and 6B are diagrams illustrating examples of a user interface (UI) according to the present exemplary embodiment of the present disclosure.

FIGS. 7A and 7B are diagrams illustrating examples of the UI according to the present exemplary embodiment of the present disclosure.

FIG. 8 is a diagram illustrating examples of the UI according to the present exemplary embodiment of the present disclosure.

FIGS. 9A and 9B are diagrams illustrating examples of the UI according to the present exemplary embodiment of the present disclosure.

FIGS. 10A and 10B are diagrams illustrating examples of the UI according to the present exemplary embodiment of the present disclosure.

FIGS. 11A and 11B are diagrams illustrating examples of the UI according to the present exemplary embodiment of the present disclosure.

FIG. 12 is a diagram illustrating a document image according to the present exemplary embodiment of the present disclosure.

FIG. 13 is a diagram illustrating an example of the UI according to the present exemplary embodiment of the present disclosure.

FIG. 14 is a flowchart illustrating UI control processing according to the present exemplary embodiment of the present disclosure.

### DESCRIPTION OF THE EMBODIMENTS

A first exemplary embodiment will be described. Hereinafter, exemplary embodiments for implementing the present disclosure will be described with reference to the appended drawings. The exemplary embodiments described hereinafter are not intended to limit the present disclosure in the scope of the appended claims, and not all of the combinations of features described in the exemplary embodiments are used in the solution of the present disclosure.

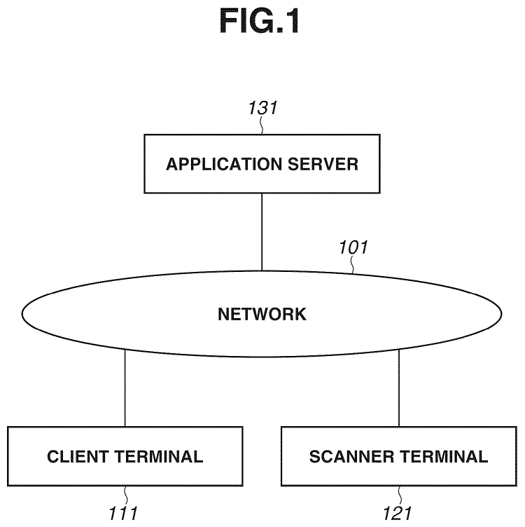

FIG. 1 is a diagram illustrating an example of a system configuration and a network configuration according to the present exemplary embodiment for implementing the present disclosure. A network 101 is a network, such as the internet or an intranet. A client terminal 111, a scanner terminal 121, and an application server 131 are included in the configuration. Examples of a client terminal 111 include various forms and types, such as a personal computer, a laptop computer, a tablet computer, and a smartphone. Examples of a scanner terminal 121 include various types, such as an office-use multifunction peripheral, an ink-jet multifunction peripheral, and a terminal dedicated to scanning. The application server 131 is provided, for example, in the form of an on-premise server, a virtual machine server provided as a hosting server in a cloud, or Software-as-a-Service (SaaS).

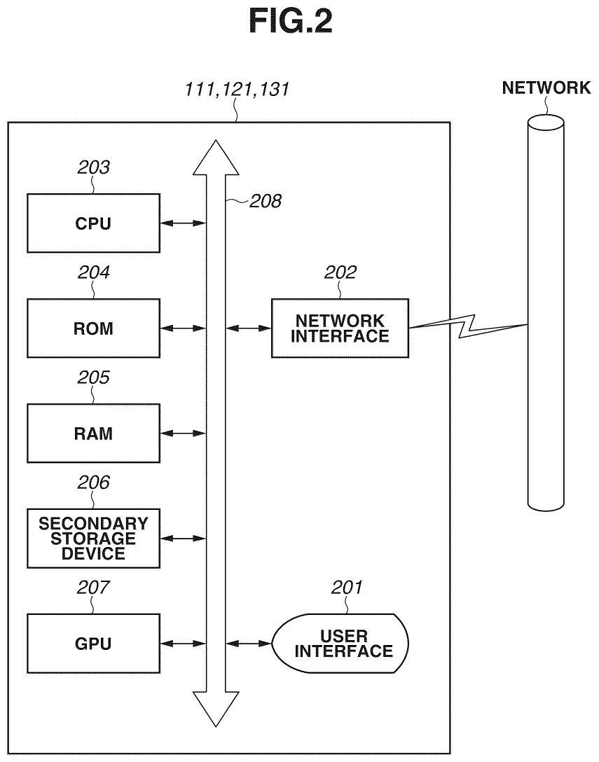

FIG. 2 is a diagram illustrating a module configuration of information processing functions of the client terminal 111, the scanner terminal 121, or the application server 131. A network interface 202 performs communication with other computers or network devices in connection to networks, such as local area networks (LAN). Wired or wireless communication may be employed as a communication method thereof. Embedded programs and data are stored in a read-only memory (ROM) 204. A random-access memory (RAM) 205 functions as a temporary storage area. A secondary storage device 206 is a secondary storage device, such as a hard disk drive (HDD) or a flash memory. A central processing unit (CPU) 203 runs programs read from the ROM 204, the RAM 205, and the secondary storage device 206. The module configuration also includes a graphics processing unit (GPU) 207. The GPU 207 is a processor dedicated to image processing, and performs image processing, rendering of output images to be displayed on a display, and a large amount of parallel arithmetic operations, such as machine learning. The module configuration does not always have to include the GPU 207. A user interface 201 outputs and receives information and signals to/from a display, a keyboard, a mouse, buttons, and a touch panel. A computer which does not include the above-described hardware can be connected to and operated by another computer through a remote desktop or a remote shell. The respective constituent elements are connected to each other via an input/output interface 208.

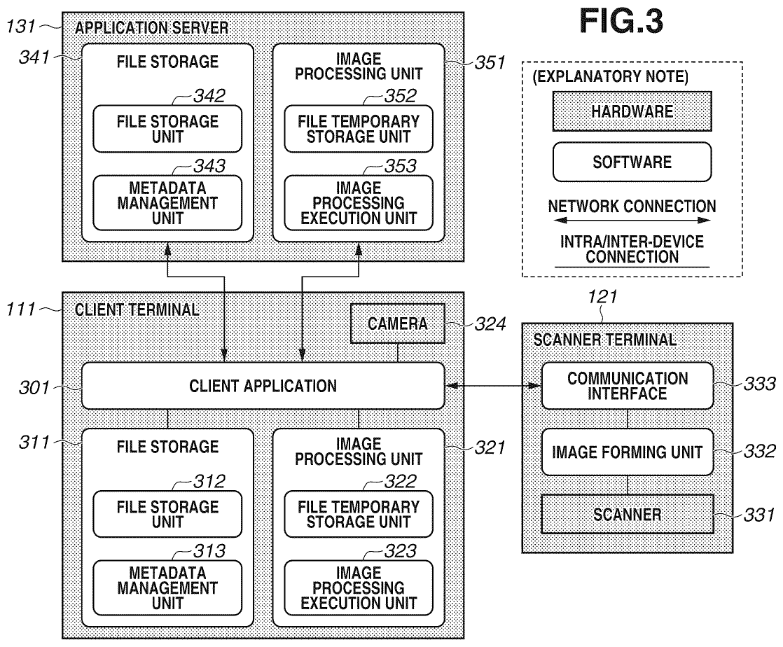

FIG. 3 is a diagram illustrating a software configuration and a hardware configuration of the system. Software installed in hardware is run by a CPU 203 included in the hardware, and can communicate with each other as indicated by an arrow representing network connection. In addition, hardware that includes a GPU 207 can be configured to allow the GPU 207 to perform image processing.

A client application 301 is run by the client terminal 111. The client application 301 often takes a form of a native application installed in and run on an operating system (OS) of the client terminal 111. This is because taking this form makes it possible to create an application accessible to all of functions of a camera and a file provided by the OS. However, when the OS includes an application programming interface (API) for enabling these functions to be used from a browser, a Web application described in a hyper-text markup language (HTML) or JavaScript may be run on the browser. In this case, the client application 301 takes a form of the browser. Hereinafter, the present exemplary embodiment is described based on the assumption that the client application 301 is used in the client terminal 111, such as a so-called general-purpose smartphone or a tablet personal computer (PC). However, the client application 301 may be run by the scanner terminal 121 if the scanner terminal 121 includes the constituent elements, such as an OS and a touch panel user interface (UI) to run the client application 301.

A file storage 311 stores and manages files. As described above, the client terminal 111 may include a storage server. The file storage 311 consists of a file storage unit 312 and a metadata management unit 313. The file storage unit 312 stores and manages binary data on a file itself. The metadata management unit 313 stores and manages metadata on each file. Although metadata on a file generally includes a date and time of creation, a file size, and a creator's name, any metadata can be stored and managed.

An image processing unit 321 performs image processing including character recognition processing, such as optical character recognition (OCR). The image processing unit 321 consists of a file temporary storage unit 322 and an image processing execution unit 323. The file temporary storage unit 322 stores files subject to the image processing performed by the below-described image processing execution unit 323 and execution results thereof. The image processing execution unit 323 reads out a file as a processing target from the file temporary storage unit 322, performs character recognition processing through the OCR, and stores an execution result file in the file temporary storage unit 322. The client terminal 111 also includes a camera 324. The client application 301 may acquire images captured by the camera 324.

A scanner 331 is mounted on the scanner terminal 121. The scanner 331 reads reflected light and color by scanning a document surface with an optical sensor. An image forming unit 332 forms a page image of a document based on optical measurement values acquired by the scanner 331. The scanner terminal 121 includes a communication interface 333. The communication interface 333 controls communication with an external device via communication protocols for wired or wireless communication, such as a LAN, a universal serial bus (USB), Wi-Fi®, and Bluetooth®. The client application 301 connects to the communication interface 333 to start scanning of a document with the scanner 331 and acquires an image generated by the image forming unit 332.

The file storage 311 and the image processing unit 321 may be arranged on the application server 131 as the file storage 341 and the image processing unit 351. The constituent elements 341 to 353 are similar to the constituent elements 311 to 323 described above, so that descriptions thereof are omitted.

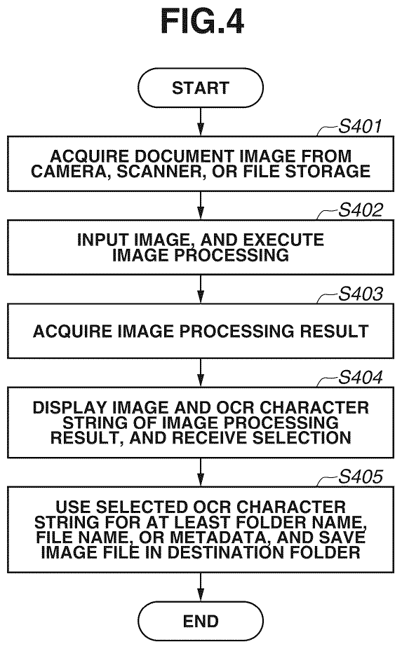

FIG. 4 is a flowchart illustrating the entire procedure of processing. The processing performed by the client application 301 illustrated in FIG. 4 is performed as arithmetic processing of the CPU 203 after a program stored in the secondary storage device 206 of the client terminal 111 is read to the RAM 205. As described above, image processing is performed by the GPU 207. In the present exemplary embodiment, although a configuration in which the following processing is performed by the client application 301 of the client terminal 111 is described, the present exemplary embodiment is not limited thereto. As described above, the following processing may be performed by the scanner terminal 121.

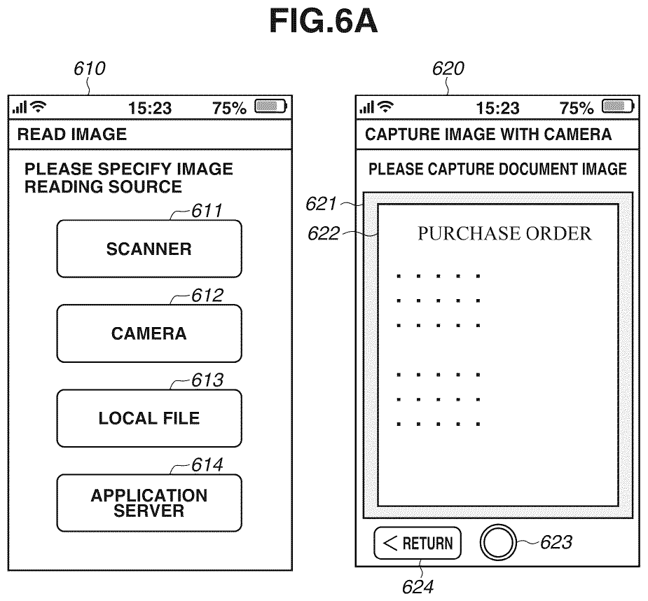

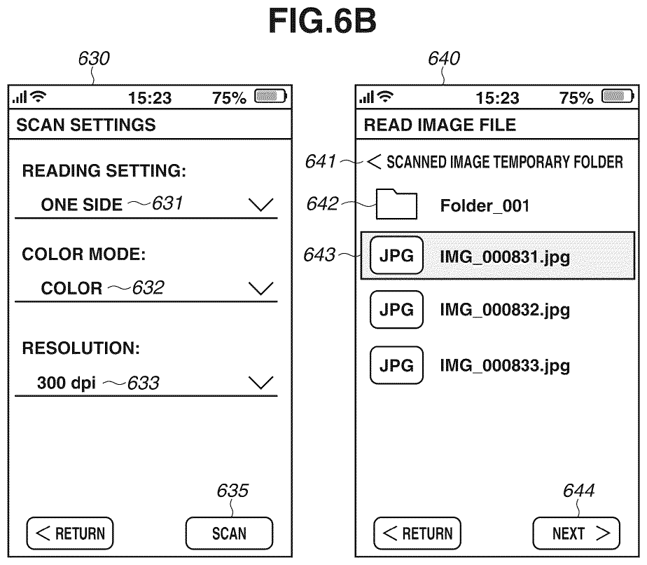

In step S401, the client application 301 acquires a document image from the camera 324, the scanner 331, or the file storages 311 and 341. In the present disclosure, image data is acquired based on a sheet of document. Specifically, the client application 301 detects a press of a camera selection button 612 displayed on a screen 610 described below in FIG. 6. The client application 301 displays a screen 620 on the user interface 201 when a press of the camera selection button 612 is detected. The user captures an image of a document by using the camera 324 included in the client terminal 111. The client application 301 detects a press of an image-capturing button 623 displayed on the screen 620, and acquires the captured image data. If the image data is to be acquired from the scanner 331, the user presses a scanner selection button 611. When a press of the scanner selection button 611 is detected, the client application 301 displays a screen 630 on the user interface 201. The user performs scan setting on the screen 630. When the client application 301 detects a press of a scan button 635 by the user, the client application 301 transmits information indicating a scanning execution instruction to the scanner terminal 121. The scanner terminal 121 receives the information and performs scanning with the scanner 331. Image data acquired through the scanning is transmitted to the client application 301 via the communication interface 333, so that the client application 301 acquires the image data. If image data is to be acquired from the file storage 311, the user presses a local file button 613 displayed on the screen 610. The client application 301 displays a screen 640 on the user interface 201 when a press of the local file button 613 is detected. Then, the client application 301 accepts a user's selection of a file from the files displayed on the screen 640. The client application 301 acquires the file selected by the user from the file storage 311. In addition, the processing for acquiring image data from the file storage 341 is similar to the processing for acquiring a file from the file storage 311 except that an acquisition source is the file storage 341 of the application server 131.

The client application 301 inputs the image to the image processing unit 321, and the image processing unit 321 stores the image in the file temporary storage unit 322. In step S402, the image processing execution unit 323 reads the image file stored in the file temporary storage unit 322, performs character recognition processing (OCR), and outputs the image processing result to the file temporary storage unit 322. In step S403, the client application 301 acquires the image processing result from the image processing unit 321. If the image processing unit 351 of the application server 131 is used, processing similar to the above-described processing is performed except that the access destination is changed to the image processing unit 351. This configuration allows image processing to be offloaded to the application server 131 with insufficient performance of the CPU 203 or the GPU 207 included in the client terminal 111. In step S404, the client application 301 displays an image and OCR character strings of the image processing result on the UI, and accepts a selection of an OCR character string. In step S405, the client application 301 uses the selected OCR character string for at least any one of a folder name, a file name, and metadata, and stores the image file in the file storage 311 or 341 as a storage destination.

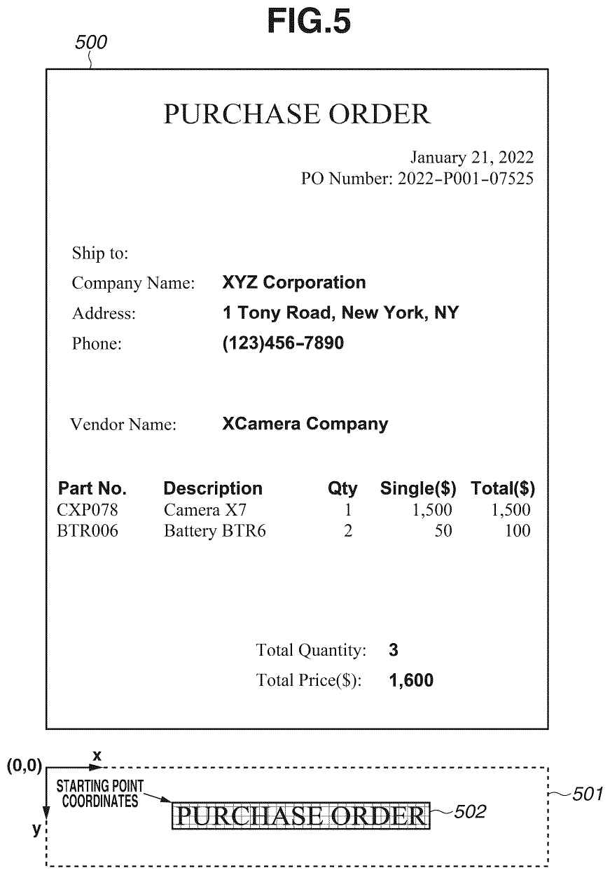

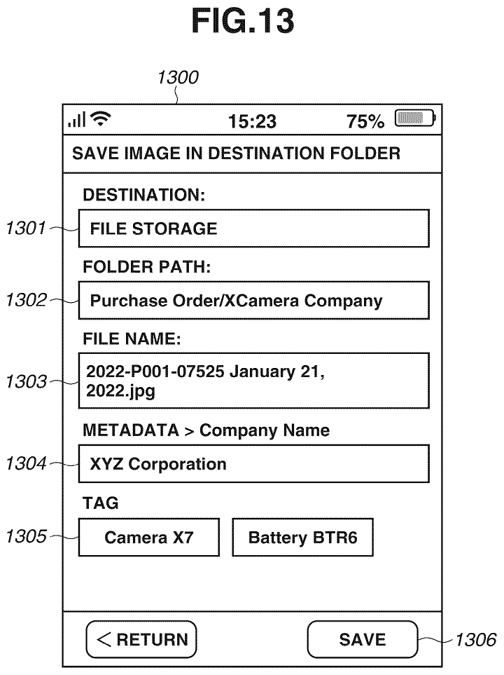

Hereinafter, the processing in steps S403, S404, and S405 will be described in detail with reference to FIGS. 5 to 14.

FIG. 5 is a diagram illustrating an image of the entire page of the document image 500 acquired in step S401. The present exemplary embodiment is described below by using a document image of a purchase order written in English. In addition, any language and any type of document can be used. In the document image 500, various types of information described in the purchase order, e.g., a date, a number, a company name, an address, a phone number, a product name, and a price, are included as character strings. An orthogonal coordinate system diagram 501 illustrates a relationship between the document image 500 and an OCR character string area 502 acquired by the image processing. When the client application 301 acquires the document image 500 as an input and performs image processing in step S402 and acquires an image processing result in step S403, the following information can be acquired as the image processing result, i.e., an OCR character string “PURCHASE ORDER” and starting point coordinates, a width, and a height of the OCR character string area 502. Further, based on the acquired OCR character string and information about a position and a size of each of the OCR character string areas, additional analysis information, e.g., information indicating whether character strings are a so-called Key-Value type character string pair and information indicating whether a character string is a key or a value, can also be included in the image processing result. For example, it is possible to detect a key and a value based on a detection of a character (e.g., a colon “:”) commonly used after a key through a syntax analysis of the character string acquired as an OCR result. Alternatively, the client application 301 may previously accept the specification of a character string as a key from the user, so that a character string corresponding to a value can also be identified when that specified character string is detected. In the document image 500, for example, a pair of character strings “PO Number:” and “2022-P001-07525” and a pair of character strings “Company Name:” and “XYZ Corporation” correspond to Key-Value type character string pairs. An OCR character string array as an image processing result acquired from the document image 500 is illustrated in Table 1. Although Table 1 also includes the information about a position and a size of the above-described OCR character string area, descriptions thereof are omitted from Table 1 in order to avoid complexity. Hereinafter, the following description continues based on a premise that information about a position and a size of an OCR character string area is certainly present for each character string.

TABLE 1
OCR Character String Array

| Character String | OCR Character | Key/Value |
|---|---|---|
| Array No. | String | Type |
| 1 | PURCHASE ORDER | |
| 2 | Jan. 21, 2022 | |
| 3 | PO Number: | K |
| 4 | 2022-P001-07525 | V |
| 5 | Ship to: | |
| 6 | Company Name: | K |
| 7 | XYZ Corporation | V |
| 8 | Address: | K |
| 9 | 1 Tony Road, | V |
| | New York, NY | |
| 10 | Phone: | K |
| 11 | (123) 456-7890 | V |
| 12 | Vendor Name: | K |
| 13 | XCamera Company | V |
| 14 | Part No. | |
| 15 | Description | |
| 16 | Qty | |
| 17 | Single ($) | |
| 18 | Total ($) | |
| 19 | CXP078 | |
| 20 | Camera X7 | |
| 21 | 1 | |
| 22 | 1,500 | |
| 23 | 1,500 | |
| 24 | BTR006 | |
| 25 | Battery BTR6 | |
| 26 | 2 | |
| 27 | 50 | |
| 28 | 100 | |
| 29 | Total Quantity: | K |
| 30 | 3 | V |
| 31 | Total Price ($): | K |
| 32 | 1,600 | V |

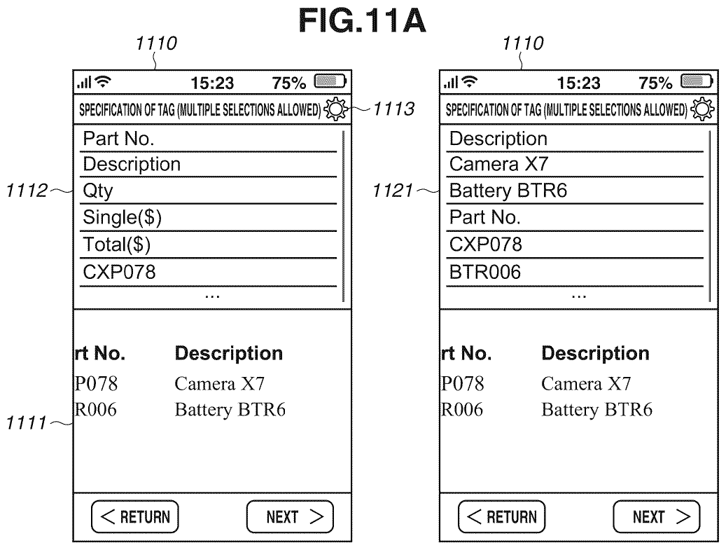

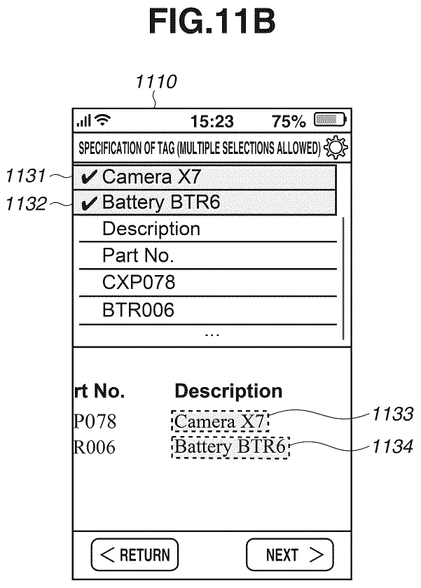

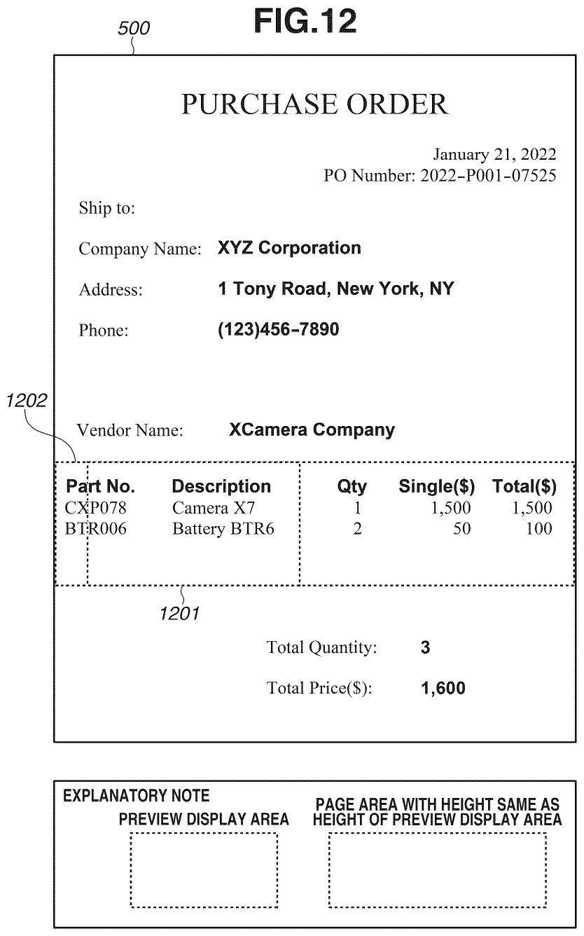

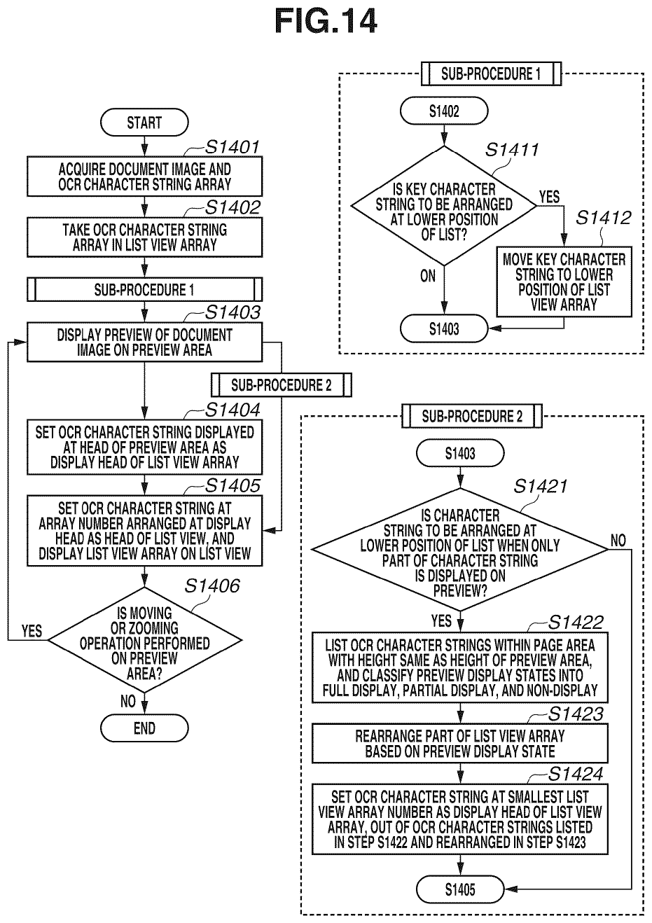

FIGS. 6A, 6B, 7A, 7B, 8, 9A, 9B, 10A, 10B, 11A, 11B and 13 are diagrams illustrating user interfaces of the client application 301. These user interfaces are displayed on the user interface 201 of the client terminal 111. For example, these user interfaces are displayed on a touch panel of a smartphone. FIG. 12 is a diagram illustrating an area within a document image. This diagram provides a supplemental description for FIGS. 11A and 11B. FIG. 14 is a flowchart illustrating UI processing.

UI control processing performed by the client application 301 will now be in order described with reference to these diagrams.

A screen 610 is a screen for reading images. On this screen 610, the user selects an acquisition source of a document image from among the scanner terminal 121, the camera 324, and the file storages 311 and 341. When the client application 301 detects a press of the scanner selection button 611 by the user, the client application 301 selects the scanner terminal 121 as an acquisition source of the document image and acquires the image data therefrom. When the client application 301 detects a press of the camera selection button 612 by the user, the client application 301 selects the camera 324 as an acquisition source of the document image and acquires the image data therefrom. When the client application 301 detects a press of the local file button 613 by the user, the client application 301 selects the file storage 311 as an acquisition source of the document image and acquires the image data therefrom. When the client application 301 detects a press of an application server button 614 by the user, the client application 301 selects the file storage 341 as an acquisition source of the document image and acquires the image data therefrom.

If the camera 324 is selected as an acquisition source of the document image, the client application 301 displays the screen 620 for capturing an image with camera 324 on the user interface 201. The user presses an image-capturing button 623 to capture an image of a document 622 in an image-capturing area display portion 621 of the camera 324. When the client application 301 detects a press of a return button 624, the client application 301 displays a previous screen (herein, the screen 610). Hereinafter, description of the return button is omitted because the operation thereof is similar.

If the scanner terminal 121 is selected as an acquisition source of the document image, the client application 301 displays the screen 630 for making scan setting. The user can make setting of one-side/two-side reading, setting for selecting a color mode or a black-and-white mode, and setting for selecting a resolution through drop-down controls 631, 632, and 633. When the client application 301 detects a press of a scan button 635 by the user, the client application 301 scans a document set to the scanner terminal 121 via the communication interface 333 and acquires the generated image data.

If the file storage 311 or 341 is selected as an acquisition source of the document image, the client application 301 displays the screen 640 for reading an image file. A control 641 displays a folder path in the file storage 311 or 341. A list view control 642 is a list view control of folder navigation. The user presses the list view control 642 to move to a target folder. The user presses the control 641 to return to the upper folder. A list view control 643 is a list view control for selecting a file in a file storage. When the client application 301 detects a press of a next button 644 after accepting a user's selection of an image file acquired as the document image via the list view control 643, the client application 301 determines a file indicated by the list view control 643 to be a reading target file, and displays a next screen (herein, a screen 710). Hereinafter, description of the next button is omitted because the operation thereof is similar. The processing up to this point corresponds to the processing performed in step S401.

The client application 301 displays the screen 710 for confirming the image after acquiring the document image from among the scanner terminal 121, the camera 324, and the file storages 311 and 341. A preview 711 displays a preview of the document image. When the client application 301 detects a press of a next button by the user, the client application 301 acquires the document image as an input and performs image processing thereon via the image processing unit 321 or 351. The processing up to this point corresponds to the processing performed in step S402.

The client application 301 displays a screen 720 for specifying a destination folder while waiting for the image processing to be ended in the background. A folder path 721 displays a folder path of the file storages 311 or 341. A list view control 722 is a list view control for displaying a list of subfolders existing in the lower level of a current folder. The client application 301 detects a press of the list view control 722 and displays a current folder 731 on a screen 730. The user presses a next button after moving the screen to a target destination folder. The client application 301 detects a press of a next button and determines the destination folder.

The following processing is described with reference to the flowchart in FIG. 14. FIG. 14 illustrates the processing in steps S403 and S404 described in detail. In the following processing, the processing in steps S403 and S404, i.e., the processing in steps S1401 to S1406, is repeated four times. The name of a subfolder as a storage destination of a file including the image data is determined in the first round of the processing, the name of the file is determined in the second round thereof, metadata to be set to the file is determined in the third round thereof, and a tag to be set to the file is determined in the fourth round thereof.

First, the processing for determining a subfolder name is described. The processing for determining a subfolder name is started when the client application 301 acquires image data and performs image processing thereon. In step S1401, as an image processing result, the client application 301 acquires the document image and the OCR character string array illustrated in Table 1 from the image processing unit 321 or 351. The processing up to this point corresponds to the processing performed in step S403. In step S1402, in order to use a list view, the client application 301 creates a list view array illustrated in Table 2 and takes the OCR character string array in Table 1 into the list view array. Data in Table 2 is exactly the same as the OCR character string array data in Table 1 except for the list view array number. The client application 301 changes the order of the OCR character string data displayed on the list view by rearranging the list view array number.

TABLE 2
List View Array

| | Character | OCR | Key/ |
|---|---|---|---|
| List View | String | Character | Value |
| Array No. | Array No. | String | Type |
| 1 (Display | 1 | PURCHASE ORDER | |
| Head) | | | |
| 2 | 2 | Jan. 21, 2022 | |
| 3 | 3 | PO Number: | K |
| 4 | 4 | 2022-P001-07525 | V |
| 5 | 5 | Ship to: | |
| 6 | 6 | Company Name: | K |
| 7 | 7 | XYZ Corporation | V |
| 8 | 8 | Address: | K |
| 9 | 9 | 1 Tony Road, | V |
| | | New York, NY | |
| 10 | 10 | Phone: | K |
| 11 | 11 | (123) 456-7890 | V |
| 12 | 12 | Vendor Name: | K |
| 13 | 13 | XCamera Company | V |
| 14 | 14 | Part No. | |
| 15 | 15 | Description | |
| 16 | 16 | Qty | |
| 17 | 17 | Single ($) | |
| 18 | 18 | Total ($) | |
| 19 | 19 | CXP078 | |
| 20 | 20 | Camera X7 | |
| 21 | 21 | 1 | |
| 22 | 22 | 1,500 | |
| 23 | 23 | 1,500 | |
| 24 | 24 | BTR006 | |
| 25 | 25 | Battery BTR6 | |
| 26 | 26 | 2 | |
| 27 | 27 | 50 | |
| 28 | 28 | 100 | |
| 29 | 29 | Total Quantity: | K |
| 30 | 30 | 3 | V |
| 31 | 31 | Total Price | K |
| | | ($): | |
| 32 | 32 | 1,600 | V |

The client application 301 displays a screen 810 for specifying a subfolder when the client application 301 identifies a destination folder by detecting a press of the next button on the screen 730. In addition, the destination folder may be identified before the processing in step S1402. Further, the processing of the sub-procedure 1 and the sub-procedure 2 is not performed in the processing for determining a subfolder name, and the sub-procedure 1 and the sub-procedure 2 is not described herein. However, the present exemplary embodiment is not so limited. The processing of the sub-procedure 1 and the sub-procedure 2 may also be performed in the processing for determining a subfolder name. The processing performed in the sub-procedure 1 and the sub-procedure 2 will be described in detail when processing for determining metadata and processing for determining a tag are described.

A preview area 811 displays a preview of the document image. The user can move a page in the vertical directions and the horizontal directions of the document image 500 by performing a swiping operation on the preview area 811. Although only upper one third of the document image 500 is displayed on the preview area 811, the user can move or change the display area to the lower part of the page by performing a scrolling operation. The user can also zoom in or zoom out the image to change the display area by performing a pinching operation. The OCR character strings extracted from the image are listed and displayed on a list view control 812, and selected therefrom. A scroll indicator 813 is displayed when many OCR character strings are not displayed as a whole on the list view control 812.

In step S1403, the client application 301 displays the acquired document image 500 on the preview area 811. Then, in step S1404, the client application 301 sets the OCR character string “PURCHASE ORDER” displayed at the head of the preview area 811 to the display head of the list view array. In other words, the client application 301 sets the list view array number 1 as the display head of Table 2. Then, in step S1405, the client application 301 sets the OCR character string at the list view array number arranged at the display head as the head of the list view control 812, and displays the list view array of Table 2 on the list view control 812. In the present exemplary embodiment, the list view control 812 can be scrolled in the vertical directions via a swiping operation, and the OCR character strings are displayed in the order of the list view array numbers of Table 2. Herein, only a limited number of character strings in the scrollable list can be displayed on the screen. In the present exemplary embodiment, the list is scrolled to show a character string arranged at the display head on the screen. A screen 820 is also a screen for specifying a subfolder. This screen 820 is displayed when the document image 500 is scrolled downward via a swiping operation performed on the preview area 811.

In step S1406, the client application 301 detects at least an operation for moving the preview area 811 to the preview area 821 or an operation for zooming the preview area 811 on the preview area 811. If the client application 301 detects at least either of the operations (YES in step S1406), the processing proceeds to step S1403. In step S1403, the client application 301 displays the updated preview of the document image 500 after the moving/zooming operation on the preview area. In step S1404, as the OCR character string “Phone:” is displayed at the head of the preview area 821, the client application 301 sets the list view array number 10 as the display head of the list view array of Table 2. In step S1405, the client application 301 updates the list view control 822 to make the character string “Phone:” at the list view array number 10 displayed at the head of the list view control 822. Specifically, the client application 301 controls the display by scrolling down the list view control 822 to a predetermined position, so that the OCR character string “Phone:” is displayed at the head of the display area of the list view control 822. Similarly, when the client application 301 detects a moving/zooming operation performed on the preview area 811, the client application 301 updates the display of the preview area 821, and further updates the display of the list view control 822 by changing the display head of the list view control 822 in conjunction with that update. In the present exemplary embodiment, the client application 301 performs display control of a list by scrolling the list view control 822 according to the display area of the image displayed on the preview area 821. Further, the list may include only character strings included in a partial area of the image data displayed on the preview area 821. With this configuration, the client application 301 may perform display control of a list to make an OCR character string displayed at the head of the preview area 821 displayed at the head of the display area of the list view control 822.

In the present exemplary embodiment, a use case in which a character string “XCamera Company” at the character string array number 13 is selected and specified as a subfolder name will be described. When the display head of the list view control 822 is updated in conjunction with the update of the display area of the preview area 821, the target character string “XCamera Company” is displayed on the list view control 822. Then, the user selects the target character string by tapping the list view control 822. When the client application 301 accepts the user's selection of the character string displayed on the list view control 822, the client application 301 highlights the selected character string to indicate a selected state.

The client application 301 further highlights a character string area 823 of “XCamera Company” in the preview area 821, which corresponds to the character string selected from the list view control 822. In this way, the user can check a character string area selected from the document image. When a press of a next button is detected, the client application 301 moves the screen to a next screen, and ends the processing of this flowchart.

The second round of the processing in steps S1401 to S1406 will now be described. In this processing, the file name of the image data is determined. The processing in steps S1401 and S1402 is similar to that of the processing for determining the subfolder name. In addition, in the second and the subsequent rounds of the processing, the processing in steps S1401 and S1402 may be omitted. In this case, a document image, an OCR character string array, and a list view array acquired in the first round of the processing in steps S1401 and S1402 are also used in the following processing. Further, the sub-procedure 1 is also omitted in the second round of the processing. In step S1403, the client application 301 displays a screen 910. The screen 910 is a screen for specifying a file name. In a use case described below, a plurality of OCR character strings is selected from the document image. A preview area 911 and a list view control 912 are similar to the preview area 811 and the list view control 812. The user performs a touch-and-hold operation to select an OCR character string 922 within the list view control 912. When the client application 301 detects the touch-and-hold operation, the client application 301 highlights the OCR character string 922 and puts a check mark thereon in order to indicate a selected state of the list view control of the OCR character string 922. The client application 301 further highlights an OCR character string area 923 in the preview area 911, which corresponds to the OCR character string 922.

The user further performs a touch-and-hold operation to select an OCR character string 931 in the list view control 912.

When the client application 301 detects the touch-and-hold operation performed on the OCR character string 931, the client application 301 highlights the OCR character string 931 and puts a check mark thereon in order to indicate a selected state of the list view control of the OCR character string 931. The client application 301 further highlights an OCR character string area 932 in the preview area 911, which corresponds to the OCR character string 931. If a plurality of OCR character strings is selected, the order thereof can be rearranged via a control 933. The user touches and holds the control 933 to drag the selected OCR character string to a desired position. As a result, the selected OCR character strings 922 and 931 are rearranged as illustrated in a result 941. When a press of a next button is detected, the client application 301 moves the screen to a next screen, and ends the processing of this flowchart.

The third round of the processing in steps S1401 to S1406 will now be described. In this processing, metadata to be set to a file including the image data is determined. The processing in steps S1401 and S1402 is similar to that of the processing for determining a subfolder name. In a use case described below, the processing in the sub-procedure 1 is also performed.

In step S1411, the client application 301 determines whether to display a key character string at a lower position of the list. Specifically, the client application 301 checks whether a toggle switch 1021 displayed on a screen 1020 is ON. If the toggle switch 1021 is not ON but OFF (NO in step S1411), the processing proceeds to step S1403. In step S1403, the client application 301 displays a screen 1010 for specifying metadata. A preview area 1011 and a list view control 1012 are similar to the preview area 811 and the list view control 812. A setting button 1013 is a setting button of the client application 301. When the setting button 1013 is pressed, the screen 1020 is open. The user can select whether to arrange a key character string of a Key-Value type character string pair at a lower position of the list by operating a toggle switch 1021. The user can select whether to arrange a character string at a lower position of the list by operating a toggle switch 1022 when only part of a character string is displayed on a preview. The toggle switch 1022 will be described below with reference to another drawing. If the toggle switch 1021 is OFF, the display order of the list view control 1012 displayed on the screen 1010 is exactly the same as that of the list view array illustrated in Table 2.

If the toggle switch 1021 is ON (YES in step S1411), the processing proceeds to step S1412. In step S1412, the client application 301 rearranges the list view array as illustrated in Table 3, so that an OCR character string whose Key-Value type is a key is displayed at a lower position thereof.

TABLE 3
List View Array (a key character string is rearranged
and displayed at a lower position.)

| | Character | OCR | Key/ |
|---|---|---|---|
| List View | String | Character | Value |
| Array No. | Array No. | String | Type |
| 1 (Display | 1 | PURCHASE ORDER | |
| Head) | | | |
| 2 | 2 | Jan. 21, 2022 | |
| 3 | 4 | 2022-P001-07525 | V |
| 4 | 5 | Ship to: | |
| 5 | 7 | XYZ Corporation | V |
| 6 | 9 | 1 Tony Road, | V |
| | | New York, NY | |
| 7 | 11 | (123) 456-7890 | V |
| 8 | 13 | XCamera Company | V |
| 9 | 14 | Part No. | |
| 10 | 15 | Description | |
| 11 | 16 | Qty | |
| 12 | 17 | Single ($) | |
| 13 | 18 | Total ($) | |
| 14 | 19 | CXP078 | |
| 15 | 20 | Camera X7 | |
| 16 | 21 | 1 | |
| 17 | 22 | 1,500 | |
| 18 | 23 | 1,500 | |
| 19 | 24 | BTR006 | |
| 20 | 25 | Battery BTR6 | |
| 21 | 26 | 2 | |
| 22 | 27 | 50 | |
| 23 | 28 | 100 | |
| 24 | 30 | 3 | V |
| 25 | 32 | 1,600 | V |
| 26 | 3 | PO Number: | K |
| 27 | 6 | Company Name: | K |
| 28 | 8 | Address: | K |
| 29 | 10 | Phone: | K |
| 30 | 12 | Vendor Name: | K |
| 31 | 29 | Total Quantity: | K |
| 32 | 31 | Total Price | K |
| | | ($): | |

Then, as illustrated in the list view control 1031, the client application 301 displays a list view control in the order rearranged in Table 3. Through the above-described processing, character strings, such as “PO Number:” and “Company Name” in the document image 500, which are less likely to be used in the folder name, the file name, or metadata, can be moved to a lower position of the list. Because only a limited number of character strings can be displayed on the list view control 1031, it is beneficial to eliminate the candidates of character strings that are less likely to be used from display-target character strings.

Further, the sub-procedure 1 may be carried out after a preview of the document image is displayed in step S1403. Specifically, when the client application 301 detects a press of the setting button 1013 while the screen 1010 is being displayed thereon, the client application 301 displays the screen 1020. When the client application 301 detects a press of the OK button after the toggle switch 1021 is switched to ON from OFF, the client application 301 moves the key character string to a lower position of the list view array and newly displays the updated list view control. Further, when the client application 301 detects a press of the OK button after the toggle switch 1021 is switched to OFF from ON, the client application 301 updates the display of the list view control according to the original list view array before the key character string is moved to a lower position thereof.

In a use case described below, the OCR character string “XYZ Corporation” is selected and input as a value of the metadata “Company Name”. When the toggle switch 1021 is OFF, the target OCR character string “XYZ Corporation” is not displayed on a displayable area of the list view control 1012. When the toggle switch 1021 is ON, the target OCR character string “XYZ Corporation” can be displayed in the list view control 1031 because the key character strings are moved to the lower positions of the list as illustrated in Table 3. When the user taps and selects the target OCR character string “XYZ Corporation” displayed on a list view control 1041, the client application 301 highlights the selected OCR character string. The client application 301 also highlights an OCR character string area 1042 in the preview area. When a press of a next button is detected, the client application 301 moves the screen to a next screen, and ends the processing of this flowchart.

The fourth round of the processing in steps S1401 to S1406 will now be described. In this processing, a tag to be set to a file including the image data is determined. The processing in steps S1401 and S1402 is similar to that of the processing for determining a subfolder name. Further, the sub-procedure 1 is omitted. In the processing described below, the sub-procedure 2 is carried out instead of the processing in step S1404. In step S1403, the client application 301 displays a screen 1110. The screen 1110 is a screen for specifying a tag. A tag is one type of metadata which generally does not require a strict type definition, such as a type definition of Key-Value type metadata. Thus, one or more pieces of additional data can freely be added thereto. The tag is also called “label”. A preview area 1111 and a list view control 1112 are similar to the preview area 811 and the list view control 812. As illustrated in FIG. 12, an enlarged partial area 1201 of the document image 500 is displayed on the preview area 1111. Table 4 illustrates a list view array which focuses on the character string included in an area 1202 which includes the partial area 1201. A column which indicates a display state of a preview is added to the right end of Table 4.

TABLE 4
List View Array (a preview display state column is added.)

| | | | |
|---|---|---|---|
| | Character | OCR | Preview |
| List View | String Array | Character | Display |
| Array No. | No. | String | State |

1 to 8: Same as Table 3

| | | | |
|---|---|---|---|
| 9 (Display | 14 | Part No. | Partial |
| Head) | | | Display |
| 10 | 15 | Description | Full |
| | | | Display |
| 11 | 16 | Qty | Non-Display |
| 12 | 17 | Single ($) | Non-Display |
| 13 | 18 | Total ($) | Non-Display |
| 14 | 19 | CXP078 | Partial |
| | | | Display |
| 15 | 20 | Camera X7 | Full |
| | | | Display |
| 16 | 21 | 1 | Non-Display |
| 17 | 22 | 1,500 | Non-Display |
| 18 | 23 | 1,500 | Non-Display |
| 19 | 24 | BTR006 | Partial |
| | | | Display |
| 20 | 25 | Battery BTR6 | Full |
| | | | Display |
| 21 | 26 | 2 | Non-Display |
| 22 | 27 | 50 | Non-Display |
| 23 | 28 | 100 | Non-Display |

24 to 32: Same as Table 3

The preview display state indicates whether a corresponding OCR character string in the preview area 1111 is displayed in a full display state, a partial display state, or a non-display state. When the toggle switch 1022 of the screen 1020 is OFF, character strings are displayed on the list view control 1112 in the order of the list view array in the table 4.

In step S1421, the client application 301 determines whether the toggle switch 1022 is set to ON. Specifically, first, the client application 301 displays the screen 1020 when a press of a setting button 1113 is detected on the screen 1110 displayed in step S1403. When a press of the OK button is detected after the toggle switch 1022 displayed on the screen 1020 is set to ON, the client application 301 determines that the toggle switch 1022 is set to ON. When a press of the OK button is detected after the toggle switch 1022 is set to OFF, the client application 301 determines that the toggle switch 1022 is not set to ON. If the toggle switch 1022 is set to ON (YES in step S1421), the processing proceeds to step S1422. In step S1422, the client application 301 lists the OCR character strings in the area 1202 with a height the same as a height of the preview area 1111, and classifies preview display states thereof into full display, partial display, and non-display. In step S1423, according to the order of full display, partial display, and non-display shown in the preview display state column, the client application 301 rearrange the list view array as illustrated in Table 5.

TABLE 5
List View Array (rearranged according to a preview display state)

| | | | |
|---|---|---|---|
| | Character | OCR | Preview |
| List View | String Array | Character | Display |
| Array No. | No. | String | State |

1 to 8: Same as Table 3

| | | | |
|---|---|---|---|
| 9 (Display | 15 | Description | Full |
| Head) | | | Display |
| 10 | 20 | Camera X7 | Full |
| | | | Display |
| 11 | 25 | Battery BTR6 | Full |
| | | | Display |
| 12 | 14 | Part No. | Partial |
| | | | Display |
| 13 | 19 | CXP078 | Partial |
| | | | Display |
| 14 | 24 | BTR006 | Partial |
| | | | Display |
| 15 | 16 | Qty | Non-Display |
| 16 | 17 | Single ($) | Non-Display |
| 17 | 18 | Total ($) | Non-Display |
| 18 | 21 | 1 | Non-Display |
| 19 | 22 | 1,500 | Non-Display |
| 20 | 23 | 1,500 | Non-Display |
| 21 | 26 | 2 | Non-Display |
| 22 | 27 | 50 | Non-Display |
| 23 | 28 | 100 | Non-Display |

24 to 32: Same as Table 3

In step S1424, after the list view array is rearranged in step S1423, the client application 301 sets an OCR character string at the smallest list view array number as the display head of the list view array, from among the OCR character strings listed in step S1422. In the present exemplary embodiment, the OCR character string “Description” at the list view array number 9 of Table 5 is set as the display head. In step S1405, the client application 301 displays the list view array rearranged according to the preview display state, illustrated in the table 5, on the list view control 1121. Through the above-described processing, a character string displayed in a full display state or a partial display state can be displayed on the list view control 1121 as a higher-order candidate, from among the OCR character strings in the area 1202 of the document image 500. In addition, as with the case of the sub-procedure 1, the above-described processing may be performed between the processing in steps S1402 and S1403. In other words, the client application 301 may check the setting of the toggle switch 1022 and display a list view control based on the list view array according to the setting before displaying the screen 1110 in step S1403.

The user performs a touch-and-hold operation on the list view control 1121 to bring the OCR character strings 1131 and 1132 used as tags into selected states. When the client application 301 detects the touch-and-hold operation, the client application 301 highlights the OCR character strings 1131 and 1132 and puts check marks thereon to indicate the selected states. Further, the client application 301 highlights the selected OCR character string areas 1133 and 1134 in the preview area 1111. When a press of a next button is detected, the client application 301 moves the screen to a next screen, and ends the processing of this flowchart. This next screen is a screen 1300 described below.

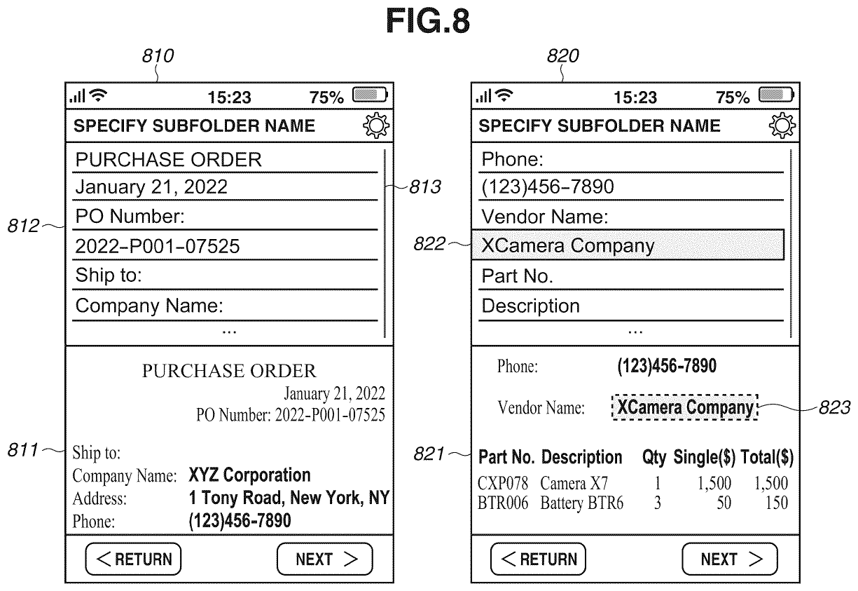

In the above-described present exemplary embodiment, the client application 301 performs control processing for switching the display of the list when the user performs at least a moving operation or a zooming operation on the image displayed on the preview area 821. For example, the screen 820 in FIG. 8 illustrates an example of a list displayed when the area displayed on the preview area 811 of the screen 810 is moved to a lower area. Further, the screen 1110 in FIGS. 11A and 11B illustrates an example of a list displayed when a partial area displayed on the preview area 1111 is zoomed and enlarged according to an instruction of the user. Furthermore, the client application 301 may perform control processing for switching the display of the list when the user reduces the display size of the image data by inputting a zoom-out instruction to the preview area. For example, if the OCR character string “Part No.” is displayed at the head of the display area of the list view control 1112 as illustrated in the screen 1110 of FIG. 11, the user inputs a zoom-out instruction to the preview area 1111. As described above, if the user reduces the image to display the entire document image 500, the client application 301 sets the OCR character string “PURCHASE ORDER” as the head of the list view array. Then, the client application 301 performs control processing for displaying the list similar to the list view control 812.

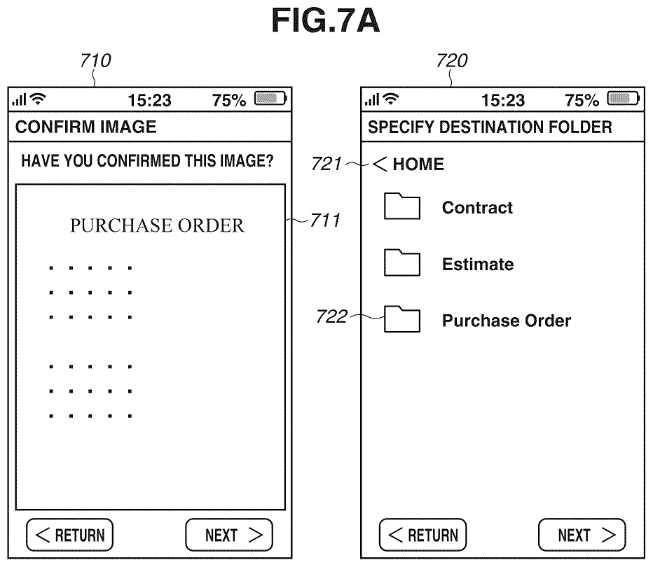

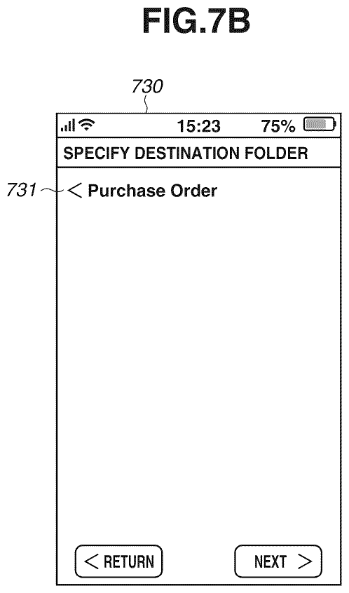

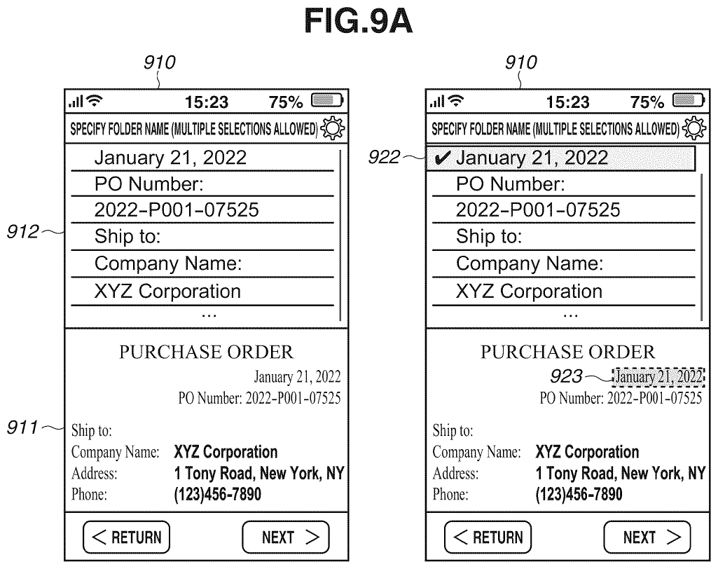

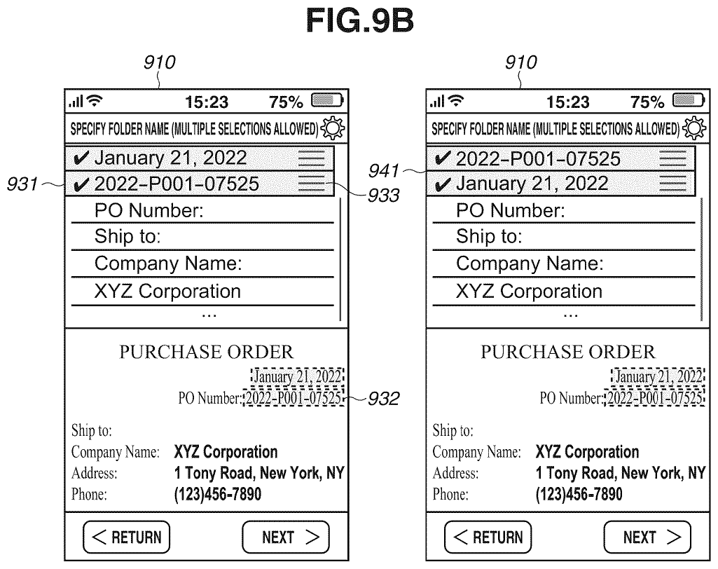

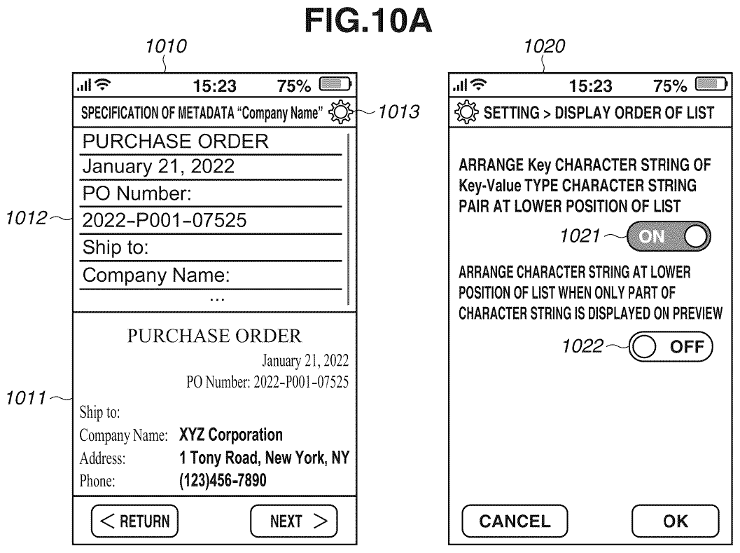

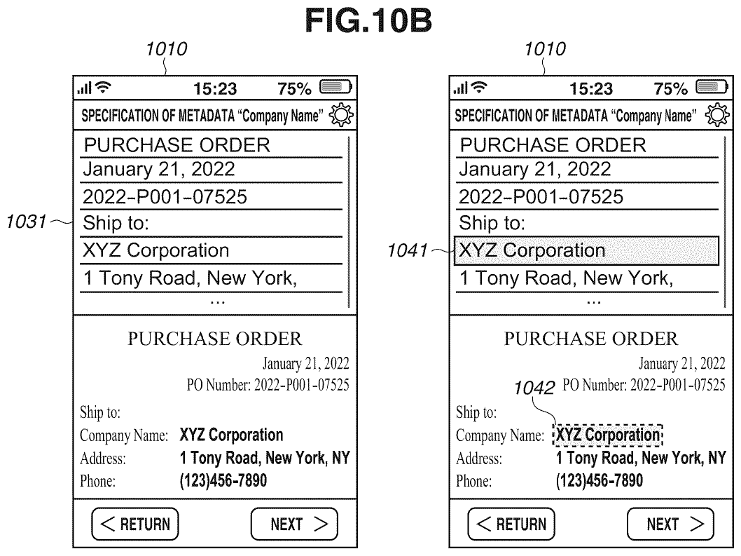

A screen 1300 is a screen for storing an image in a storage destination. A text control 1301 indicates the destination name of the file storage 311 or 341 as a storage destination. A text control 1302 indicates a folder path specified and selected on the screens in FIGS. 7A and 7B, and 8. A text control 1303 describes a file name specified and selected on the screen in FIGS. 9A and 9B. A text control 1304 indicates a file name specified and selected on the screen in FIGS. 10A and 10B. A text control 1305 indicates one or more tags specified and selected on the screen in FIGS. 11A and 11B. When a save button 1306 is pressed, the client application 301 stores the document image in the file storage 311 or 314 as a storage destination under the specified folder path and the specified file name. Further, if metadata (including a tag) is specified, the client application 301 simultaneously stores the metadata in the file storage 311 or 314 as a storage destination together with the document image. The processing up to this point corresponds to the processing performed in step S405 of the entire processing procedure.

In the present exemplary embodiment, the UI control method for selecting a desired OCR character string from an image through a client application has been described. Even if a client terminal has limitations on operations unique to a touch panel UI, i.e., tapping, swiping, and pinching operations, due to an insufficient display size, it is possible to easily and quickly select a desired OCR character string in an image. This configuration solves the above-mentioned issue by improving the operational efficiency of selecting a desired OCR character string in an image via a touch panel UI for selecting an OCR character string in an image.

### Other Exemplary Embodiments

The present disclosure can be practiced through processing in which a program for carrying out one or more functions according to the above-described exemplary embodiment is supplied to a system or an apparatus via a network or a storage medium, and one or more processors in the system or the apparatus read and run the program.

Further, the present disclosure can also be practiced with a circuit, such as an application specific integrated circuit (ASIC) or a field programmable gate array (FPGA), which carries out one or more functions.

The client terminal according to the present exemplary embodiment of the present disclosure provides a system for appropriately displaying a list of character strings acquired by performing character recognition processing on image data according to a changed display area of the image data based on instructions of enlargement and reduction.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-192636, filed Dec. 1, 2022, which is hereby incorporated by reference herein in its entirety.

What is claimed is:

1. A client terminal configured to:
acquire image data acquired from a document;
perform character recognition processing on the image data; and
control display of at least a partial area of the image data specified based on an instruction issued by a user and display of a list of character strings acquired by the character recognition processing,
wherein, as at least the partial area to be displayed is changed, the list of character strings is changed so that character strings recognized in at least the partial area are displayed.

2. The client terminal according to claim 1,
wherein the instruction issued by the user is at least any one of an instruction for enlarging display of at least the partial area and an instruction for reducing display of at least the partial area, and
wherein at least the partial area specified and displayed based on the instruction is changed.

3. The client terminal according to claim 1,
wherein the list is displayed in a scrollable form, and
wherein the list is scrolled to a predetermined position and displayed so that the character strings recognized in the partial area are displayed.

4. The client terminal according to claim 1, wherein only character strings included in the partial area are included in the list so that the character strings recognized in the partial area are displayed.

5. The client terminal according to claim 1, wherein, out of the character strings recognized in the partial area, a character string only a part of which is included in the partial area is arranged at a lower position of the list.

6. The client terminal according to claim 1, wherein, out of the character strings recognized in the partial area, a character string only a part of which is included in the partial area is not included in the list.

7. The client terminal according to claim 1,
wherein a combination of a character string as a key and a character string as a value corresponding to the key is further recognized by the character recognition processing, and
wherein, out of the character strings recognized in the partial area, the character string as a key is arranged at a lower position of the list.

8. The client terminal according to claim 1, further configured to:
accept selection of a displayed character string included in the list; and
set information about the image data to the image data.

9. The client terminal according to claim 8, wherein the selected character string is extracted from the list and displayed.

10. The client terminal according to claim 8, wherein the information is set by using the selected character string.

11. The client terminal according to claim 8, wherein the information is at least any one of a name of a file which includes the image data, a name of a folder in which the file is to be stored, and metadata set to the file.

12. The client terminal according to claim 1, comprising a camera,
wherein the image data is acquired by capturing an image of a document with the camera.

13. The client terminal according to claim 1, comprising a scanner,
wherein the image data is acquired by scanning a document with the scanner.

14. The client terminal according to claim 1, comprising a storage server,
wherein the image data is acquired from the storage server.

15. The client terminal according to claim 1, comprising a touch panel,
wherein the image data and the list are displayed on the touch panel.

16. A control method of a client terminal, the control method comprising:
acquiring image data acquired from a document;
performing character recognition processing on the image data; and
controlling display of at least a partial area of the image data specified based on an instruction issued by a user and display of a list of character strings acquired by the character recognition processing,
wherein, as at least the partial area to be displayed is changed, the list of character strings is changed so that character strings recognized in at least the partial area are displayed.

17. A non-transitory computer-readable storage medium storing a computer program for executing a control method of a client terminal, the control method comprising:
acquiring image data acquired from a document;
performing character recognition processing on the image data; and
controlling display of at least a partial area of the image data specified based on an instruction issued by a user and display of a list of character strings acquired by the character recognition processing,
wherein, as at least the partial area to be displayed is changed, the list of character strings is changed so that character strings recognized in at least the partial area are displayed.
